(19) United States
(12) Patent Application Publication
(10) Pub. No.: US 2022/0272128 A1
(43) Pub. Date: Aug. 25, 2022

(54) ZERO-TRUST DECENTRALIZED CYBERSECURITY ARCHITECTURE FOR ENDPOINT DEVICES

(71) Applicant: ARMIN BABAEI, Frankfurt (DE)

(72) Inventor: ARMIN BABAEI, Frankfurt (DE)

(21) Appl. No.: 17/740,205

(22) Filed: May 9, 2022

(51) Int. Cl. H04L 9/40

(52) U.S. Cl. CPC H04L 63/20; H04L 63/101; H04L 63/1425

(57) ABSTRACT

The present invention provide a zero-trust decentralized cybersecurity architecture solution. This zero-trust decentralized cybersecurity architecture should cover features like least privilege access control, two-factor authentication, and support secure messaging, support secure emailing, detecting phishing support secure notifications with preserving confidentiality, integrity and non-repudiation. The zero-trust decentralized cybersecurity architecture solution using blockchain technology addresses cybersecurity requirements to build up a secure collaborative environment between enterprises, internally and externally. Integrating blockchain technology (as the core of the present invention) provides a zero-trust decentralized cybersecurity architecture. The present invention has no central core and has no dependency on 3rd parties (decentralized). Therefore, each node needs to prove its reliability through cybersecurity measures integrated into the present invention (zero-trust). The proposed zero-trust decentralized cybersecurity architecture (the present invention solution) is enriched with: 1) two-factor authentication, secure emailing/messaging/notification and 2) secure file sharing and access management based on role-based access control (RBAC) mechanism.

### TECHNICAL FIELD

The present invention relates to security techniques and methodologies for protecting computer systems, software and data (cyber-security techniques and methodologies) in both real and virtual instantiations, such as cloud-based instantiations using virtual machines.

### BACKGROUND

Assuring cybersecurity of platforms is a complicated and resource-intensive task which is often remain understudied due to following three main reasons:

Insufficient resource allocation such as funding, and infrastructure: Even large enterprises have no interest, resource or motive to expand their capabilities for cybersecurity measures and integration of cyber-security standards-guidelines such as DFARS Clause 252.204-7012, SP800-207, and IEC62443. The condition often becomes worse for small-medium size enterprises also known as SMEs, due to the lack of financial resources and personnel. Due to the lack of resources, SMEs often skip integration of cybersecurity measures and cybersecurity standards-guidelines in their systems.

Human errors such as downloading from insecure platforms, phishing attacks, and duplicating files: According to an IBM study: “human error is the cause” of 95% of cybersecurity breaches, although part of these errors can be eliminated by cybersecurity awareness training. However, the internal and external interactions/communications/collaboration in enterprises (e.g. emails, lack of role-based access control (RBAC) on files and devices, updates and notifications, data repository . . . ) increases the risk of these errors. Also, there is no active user monitoring mechanism to determine potential cybersecurity breaches in advance.

Too much focus on centralized cybersecurity architectures which, to some extent, resembles egg architecture, hard from outside (hard shell) and soft from inside (soft core): Cybersecurity breaches on Merck Enterprise in 2019 (https://www.bloomberg.com/news/features/2019-12-03/merck-cyberattack-s-1-3-billion-question-was-it-an-act-of-war) are one of the examples of the fragility of centralized cybersecurity architecture. In the centralized cybersecurity architectures, the vulnerability can expand easily and quickly throughout the entire enterprise during a security incident, e.g. unauthorized access, cybersecurity breaches.

Legacy IoT/OT devices in production lines: Legacy devices in general have no or weak cybersecurity measures. These devices are normally expensive, and their lifetime can even be extended to decades. Updating IoT/OT legacy devices are not easy, because any update/modification might lead to effect on device normal operation.

Therefore, enterprises need to proceed toward zero-trust decentralized and plug-and-play cybersecurity architecture. However, to address each of the aforementioned problems, enterprises are facing certain challenges as categorized below with respect to the problems, few of which are recited below:

Lack of resources to implement necessary modifications on the internal processes and internal IT infrastructure. Integrating cybersecurity standards-guidelines with internal processes is a complex task, which is specifically resource-inefficient or cost-inefficient. Therefore a seamless and cost-efficient plug-and-play type of a solution is needed which does not require so many interactions with users and so many interactions with internal processes. Enterprises must meet cybersecurity standards-guidelines and risk management framework (RMF) compliance for integrating this solution.

Human errors often occur due to lack of an active user monitoring mechanism to correct user behavior. While artificial intelligence (AI) machine learning (ML) techniques can eventually address this challenge, the challenge is still relevant in most applications. In long-run, the main challenge toward integrating AI/ML on node level (running on employees' computer) is that these techniques in general require considerable computational power which can have an effect on normal user activities (e.g. slowing down the computer in processing a task, running other programs slowly . . . ). Therefore a lightweight AI-based monitoring solution is required to monitor and audit user behavior (e.g. data movement, downloads.). Furthermore, in case of security incident, this AI/ML-based solution must notify the enterprise responsible personnel.

Centralized cybersecurity architecture is often chosen due to its insignificant integration cost. One possible solution here is to integrate zero-trust decentralized cybersecurity architecture into centralized IT infrastructure. In general, IT infrastructure contains server (center), gateways (mid-center), and end point nodes or edges (e.g. computers or electronic devices in general) which build a centralized IT infrastructure (shown in FIG. 1). Enterprises usually integrate security architecture into their own centralized IT infrastructure. Therefore, these security architectures will turn automatically into a centralized architecture as well due to the centralized IT infrastructure footprint. Consequently for wide adaptation, a good zero-trust decentralized cybersecurity architecture solution is expected not efficient.

Legacy IoT/OT: These devices in general from SW/HW perspectives have no flexibility. According to their age, there are not so many guidelines how the system works internally. Therefore, any modification and update on these devices brings the risks that the IoT/OT device does not work as before. Besides this, cybersecurity measures require considerable computational power. Updating cybersecurity measure in IoT/OT device effects on device normal operation and as the consequence it might lead to safety issues.

FIG. 1 illustrates a centralized IT infrastructure. This architecture is similar to an egg architecture (centralized with hard shell and soft core) which is mentioned before; Enterprise servers have normally multilayers of securities on servers and gateways (hard shell of the egg analogy) for communicating with the outside world (outside the enterprise). Internal end point nodes (soft core of the egg analogy) are normally trusted in this illustrated infrastructure.

### SUMMARY OF THE INVENTION

Embodiments of the invention provide a zero-trust decentralized cybersecurity architecture solution. This zero-trust decentralized cybersecurity architecture should cover features like least privilege access control, two-factor authentication, and support secure messaging, support secure emailing, secure file sharing, phishing detection, role based access control (RBAC), support secure notifications with preserving confidentiality, integrity and non-repudiation based on blockchain.

All objects, features and advantages of the present invention will become apparent in the following detailed written description.

The Summary is neither intended nor should it be construed as being representative of the full extent and scope of the present invention, which these and additional aspects will become more readily apparent from the detailed description, particularly when taken together with the appended drawings.

The zero-trust decentralized cybersecurity architecture solution using blockchain technology addresses cybersecurity requirements to build up a secure collaborative environment between enterprises, internally and externally. Integrating blockchain technology (as the core of the present invention) provides a zero-trust decentralized cybersecurity architecture. The present invention has no central core and has no dependency on 3rd parties (decentralized). Therefore, each node needs to prove its reliability through cybersecurity measures integrated into the present invention (zero-trust). The proposed zero-trust decentralized cybersecurity architecture (the present invention) is enriched with: 1) two-factor authentication, secure emailing/messaging/notification and 2) secure file sharing and access management based on role-based access control (RBAC) mechanism.

The present invention also provides an extra layer of security based on a lightweight Artificial Intelligence (AI) based anomaly detection to monitor and audit user behaviors on endpoint devices (e.g., PC, Laptops, Mobile Phones, Operation technology (OT)/Internet of things (IOT) devices). Therefore, when a security incident happens, it will be reported to the responsible personnel. Furthermore, this lightweight Artificial Intelligence (AI) security layer also by auditing the device cybersecurity measure predicts potential vulnerability and gives suggestions to the responsible personnel.

All the above mechanisms will be integrated on endpoint devices. As a result, these mechanisms are in form of plug-ins and add-ons. Therefore, it will be a seamless, ubiquitous, and plug-and-play solution that does not need any configuration. The present invention simplifies the utilization of cybersecurity measures for normal employees to work in a secure collaborative environment.

The present invention also follows cybersecurity standards-guidelines, i.e. compliant with DFARS clause 252.204-7012, SP800-207, DoD zero-trust reference architecture version 1.0 and IEC62443-3.

The present invention (zero-trust decentralized cybersecurity architecture) is to build a secure collaborative environment with at least three below provided benefits:

The present invention is a plug-and-play solution, i.e. it does not require any configuration or modification on the IT infrastructure. Therefore it is cost-efficient and easy to use.

The present invention is compliant with cybersecurity standards-guidelines, i.e. by integrating solutions of the present invention the enterprises automatically will be compliant with DFARS clause 252.204-7012, NIST SP800-207, and DoD zero-trust reference architecture and IEC62443-3. These feature eligible enterprises to get involve easier in governmental and confidential projects.

In this embodiment, the computing device is configured to perform at least one of: detection, based on the blockchain, one or more phishing email received at the computing device; secure email communication, based on the blockchain, from the computing device; secure file sharing, based on the blockchain, from the computing device, wherein the secure file sharing is performed based on role-based access control (RBAC) mechanism; and/or secure identity access management, based on the blockchain in the computing device; and/or secure control access management, based on the blockchain, in the computing device; and/or secure device management, based on the blockchain, in the computing device.

In an example, according to the present invention model, each employee has a dedicated NFT. The NFT is authorized by the company who owns the NFT. The NFT contains the employee information like email, company name, public key (or Certificate), user role (employee, manager, supervisor etc.) and access based on the user role.

For an example, when an employee A in company X want to send a secure email to the employee B in company Y. it should follow the following process:

Employee A write the email of the recipient (Employee B in company X);

The developed add-on or plugin which is added to the email software client (e.g. Outlook) will search through the blockchain and find the user's NFT and readout the user required information and bring it back to the email software client;

Then the employee A will encrypt the email with employee B public key and sign it with his own private key;

When user B receives the email, the add-on automatically by looking into the email address, look for the sender's NFT in blockchain, and read required information from the corresponded NFT;

If the person had a valid NFT, it will proceed otherwise raise a warning that it might be a phishing email and phishing attack;

The receiver fetches the information (e.g., public key) and verifies the cryptographic signature of the user. If it is valid then it will decrypt the email;

Such an approach is valid for multiple recipient of the email or only one person. This concept can be done in public or private blockchain.

In another example, as described above, each user has a NFT. Users can encrypt the file with the provided software in form of add-on or plugin. The software provides the possibility to specify with whom this file can be shared. It is also possible to specify with which group of people or with which role this file can be shared (Role based access control). So the procedure of secure file sharing is as follow:

The user specifies the file can be shared with whom or group of people with the same role;

The user by using the provided software encrypts the file and specifies the person or the roles that, who can decrypt the file.

Then the user share the file into the sharing platform (e.g. drop box, share point, google drive etc.);

The key of the secured file will be shared in the blockchain as a small parts or completely to the decentralized leasing platform (DLP) or a server that keep the keys;

Then when the recipient or people with similar or higher roles download the file and want to decrypt it. The software sends a request to the server or DLP to provide them the key to decrypt the file;

DLP or the server verify the request and read out the user's NET. if he/she has access according to his identity or his role, then the key for the file will be shared with the user, otherwise the user will not receive the key;

When the software receives the key, it will decrypt the file for the recipient.

The present invention also has room/capacity for human errors in order to minimize potential security incident caused by human errors.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 illustrates a centralized IT infrastructure as well known in the prior-art.

FIG. 2 is zero trust decentralized cybersecurity architecture, according to an embodiment of the present invention.

FIG. 3 is a simplified diagram of a blockchain, according to an embodiment of the present invention.

FIG. 4 illustrates software component diagram of the zero trust decentralized cybersecurity architecture which includes three key subsystems (components), according to an embodiment of the present invention.

FIG. 5 is a task AI at a glance, according to an embodiment of the present invention.

FIG. 6 is a state of the art hardware security module (HSMS).

FIG. 7 is a computing device/a plug-and-play device to manage user identities and roles using blockchain and to facilitate secure communication, according to an embodiment of the present invention.

FIG. 8 is a method performed by the computing device/a plug-and-play device as shown in FIG. 7.

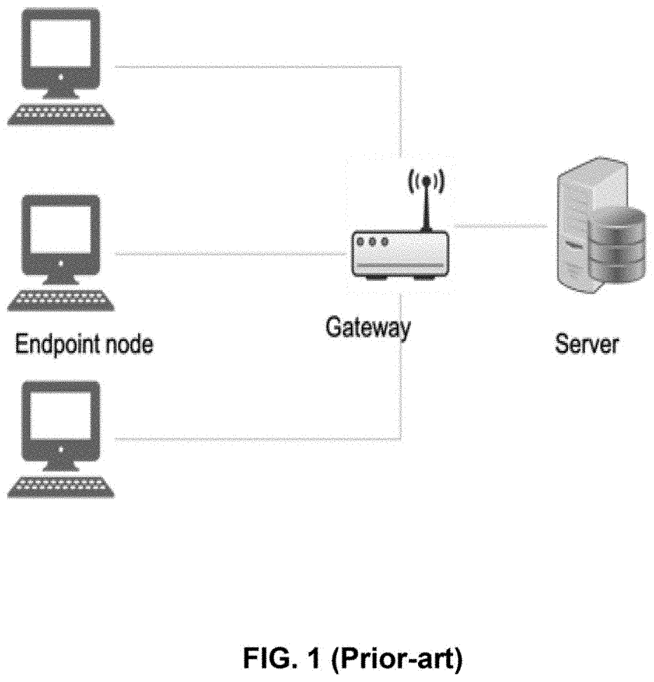

### DETAILED DESCRIPTION OF DRAWINGS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure.

In the following description, numerous specific details are set forth in order to provide a thorough understanding of embodiments of the present invention. It may be apparent to one skilled in the art that embodiments of the present invention may be practiced without some of these specific details.

Various terms as used herein are shown below. To the extent a term used, it should be given the broadest definition persons in the pertinent art have given that term as reflected in printed publications and issued patents at the time of filing.

Embodiments of the invention provide provides zero-trust decentralized cybersecurity architecture based on blockchain technology. The present invention provides a secure and dependable platform that can be used for cybersecurity application. Among different generations and types of blockchain ledgers, a blockchain platform is chosen (in preferred embodiment) using the open-source blockchain software package, the present invention will be entirely built on existing blockchain platform without modifying the base code. A person skilled in the art would appreciate that blockchain platform is a next-gen blockchain platform that delivers privacy, scalability, and security, making it the DLT platform of choice for financial services and beyond.

In an embodiment, the overarching goal of the present invention is to provide the following two concurrent layers of security which will be implemented within blockchain base platform:

Layer 1: to support secure data sharing, secure notifications and secure messaging from an unauthorized access, the present invention integrate a role-based access control (RBAC) model to address authorization problem as one of the challenge mentioned in background. Users need to login via a two-factor authentication process, which will be chosen based on availability among multiple authentication methods provided to the users. All security measures are updatable which solve the problem mentioned in one of the challenge mentioned in the background.

Layer 2: to develop a machine-learned (AI-based monitoring) security layer to detect potential cyber-attack (i.e. security incident), by searching for anomaly in user behavior and detecting compromised devices; Also to notify the other users of a potential security incident or compromise via broadcasting (i.e. reporting) this potential security incident as a message through blockchain: Known as security incident and event management (SIEM) message in cybersecurity community for security incident reporting purposes.

In an embodiment, the present invention has following distinctive features:

Implementation of the present invention is through a proprietary plug-ins or add-ons. Independent from the OS of the end-users. These plug-ins or add-ons are connected to blockchain platform which automatically integrates the user interactions with blockchain itself.

The present invention is one step toward implementation of zero-trust decentralized cybersecurity architecture in enterprises by following DFARS Clause 252.204-7012 (Safeguarding Covered Defense Information), NIST 800207, IEC62443-3 and department of defence DOD zero-trust Reference Architecture Version 1.0 guidelines.

The present invention has no effect per se on enterprises IT infrastructure and does not require configuration or modifications as mentioned in the beginning of this section.

The present invention enables secure messaging (by Secure emailing and OPC-UA protocol), secure update, secure remote maintenance, role-based access control model, two-factor authentication, and node level user activity monitoring and Auditing based on AI technology, i.e. AI-based monitoring.

The present invention is now explained from the perspective of different stages as recited below:

Identity and Access Management Using Blockchain:

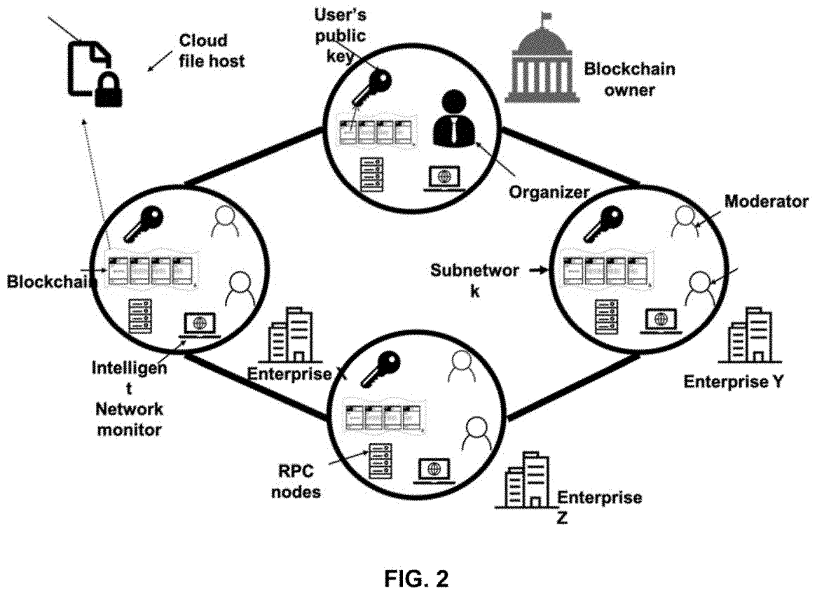

FIG. 2 provides zero trust decentralized cybersecurity architecture. To elaborate, the blockchain owner will organize the network by allowing Enterprises to have its own sub-network. An enterprise sub-network will have a moderator, a set of users, a blockchain ledger, remote procedure calls (RPC) nodes to facilitate device access, and an intelligent network monitor (AI-based monitoring). Encrypted files will be hosted on cloud and keys will be securely stored/shared on the blockchain.

As well known in the art, contemporary identity and access management (IAM) systems are centralized, where designated servers store authentication and access information of users. However, there are several issues associated with contemporary IAM systems. First, since most of the information stored on these servers is not encrypted, when these servers gets backed, all the users' information is compromised (e.g., Equifax data breach, Merck cyber-attack). Second, since contemporary IAM systems are not tamper resistant, it is difficult for SMEs to implement DFARS Clause 252.20 7012, NIST 800-207, IEC62443-2. Third, most of the contemporary IAM systems do not facilitate secure communication among the users, and IoT/OT devices using end-to-end encryption.

Current solutions relies on trust based architecture for secure information sharing, and therefore is not suitable for implementing zero-trust Reference Architecture.

Accordingly, to eliminate the above issues, the present invention provides a framework which is made of three primary subsystems. (i) The first subsystem is based on the blockchain. (ii) The second subsystem of the present invention is made of add-ons and plug-ins to facilitate users' interaction with the blockchain using User interfaces (UI). The UI section defines the services which a user can get from the blockchain. (iii) The third subsystem will facilitate integration of hardware keys. In the following, detail the design and implementation of these three subsystems are provided.

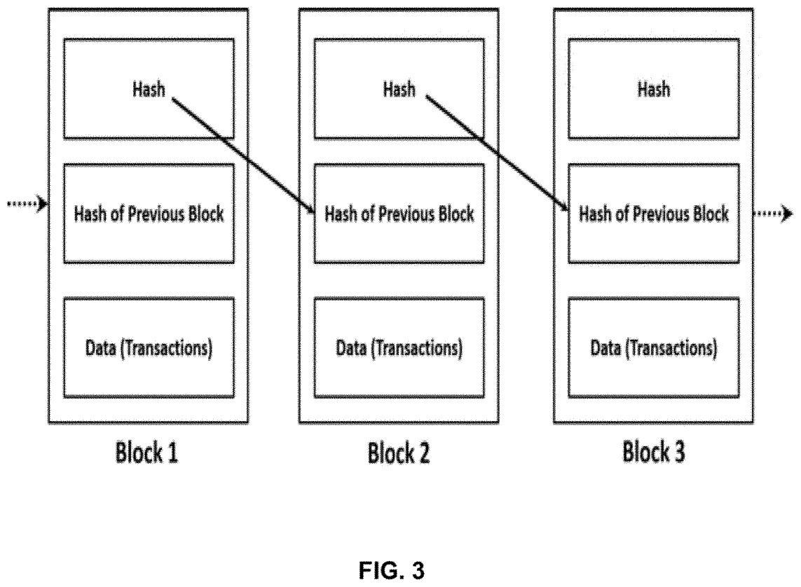

Blockchain Subsystem: Blockchain is a decentralized, distributed, peer-to-peer, transparent, immutable, and append-only data storage. It keeps a permanent record of writes called transactions. Multiple transactions are grouped in blocks. Each block in a blockchain contains its hash computed using a well-known hashing algorithm (e.g., SHA256, SecureHash, ethash, and equihash) and the hash of the previous block called parent block (FIG. 3). Therefore, in a blockchain, each block is tied (aka chained) to parent using parent's hash. Therefore, if any block is tampered with, it will invalidate all the subsequent blocks.

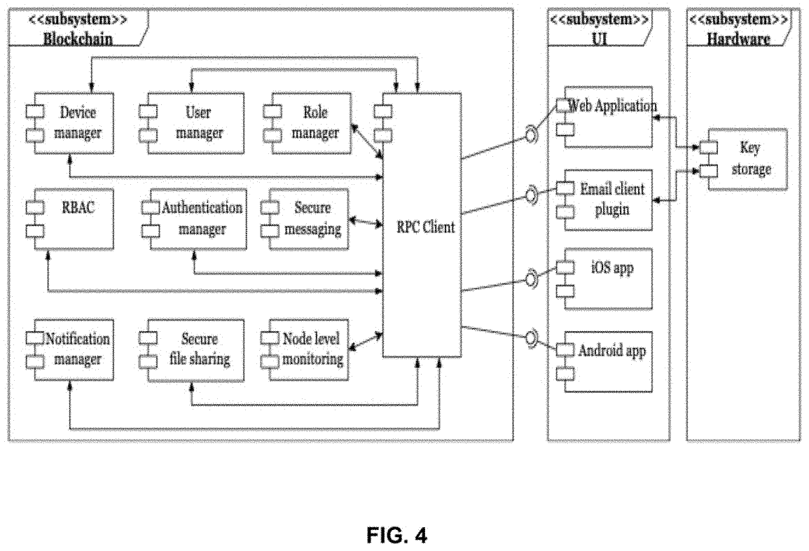

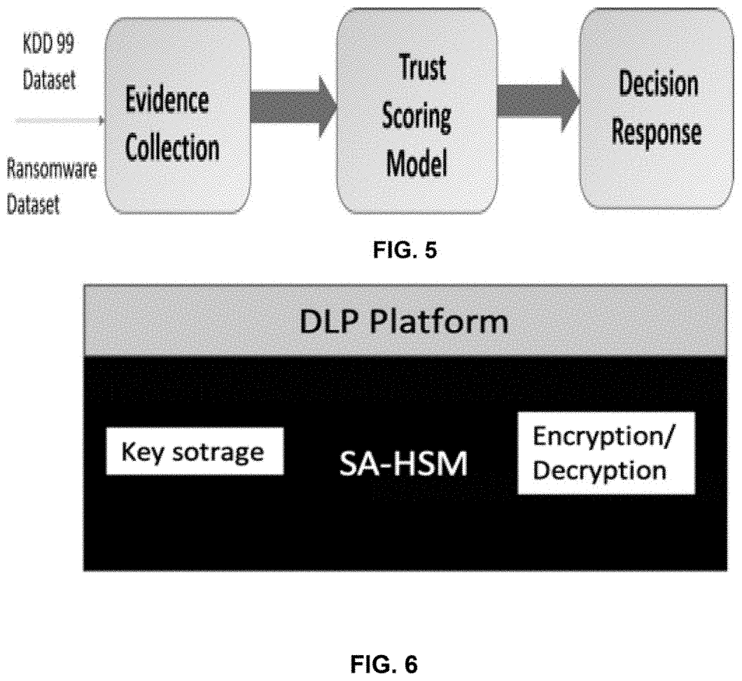

FIG. 4 provides a software component diagram of the present invention which includes three key subsystems (components): The blockchain subsystem implements the users, role, device, access control, notification, and monitoring. A RPC interface facilitates access to the blockchain from UI, which includes web and mobile apps. Hardware key storage facilitates remote access from unregistered devices.

Blockchain platforms can be categorized into two groups. Public blockchains are decentralized with no single entity controlling the network and everyone and anyone can join the network. Examples include: Bitcoin, Ethereum, Litecoin, and Cardano. Private blockchains operate on permissioned networks and are with a single entity or a group of entities controlling the network. Popular platforms to manage private blockchains include: Hyperledger, Quorum, Corda, and IBM blockchain

The key characteristics of the customized blockchain designed for the present invention is as follows:

(a) sub-network architecture: The present invention utilizes sub-network architecture. In this model, a node is un-aware of other subzones, as it sees only those nodes registered with the Network Map service that it has also registered with itself. (b) Smart-contracts: Smart-contracts are self-executing contracts with the terms of the agreement among two more parties of transactions written using lines of code instead of a legal language. The present invention will use smart contracts to manage users, their roles, and implementation of role-based access control (RBAC). (c) Users: In this model each user has a smart-contract. This smart-contract has various information regarding a user, which include: (i) email Address, (ii) full Name iii) certificate (i.e., public key), (iii) role, and (iv) company name, and (v) tenure information. (d) Roles: Each user, according to his/her role can perform some tasks and interact with the blockchain. (e) Role-based access control (RBAC): The present invention will develop RBAC protocol using smart contracts. Motivated by a similar prior implementation, smart contract based solution of the present invention will have following properties. 1) Management: Moderators can manage and modify information. 2) Revocation: Role issuing organizations can revoke the roles issued to users if needed. 3) Verification: Any entity can verify the user-role assignment through a challenge-response protocol. 4) Monitoring: All actions (functions executed) performed in the smart contract are recorded and any entity can audit these actions. Due to the inherent characteristics of blockchain, all changes have integrity and are non-repudiable. 5) Restriction: An entity can only perform specific actions and cannot perform actions on behalf of other entities or as other entities. (f) User Management: A new user creation must be initiated by that person and would follow a defined protocol. (g) User Authentication: Each user will be associated with a blockchain Node. Users can interact with this node using Remote Procedure Calls (RPC). A user needs to authenticate to his/her node using his/her user name, password, and a second form of authentication tokens. (h) Device management: To use a sub-network each device must be registered to a Node belonging to that sub-network. Devices interact with a node using a RPC client. To ensure that only authenticated devices can access network, the present invention will use the Non-Fungible Token (NFT) concept as implemented in the blockchain. According to the implementation of the present invention, a NFT is created for each device and those NFTs are included in a smart-contract owned by the moderator of the sub-network.

User Interface Subsystem:

The present invention provides a user friendly web, PC and mobile applications to facilitate user's interaction with the blockchain. Since goal of the present invention is not to interfere with an organization's existing IT infrastructure, the present invention intent to integrate the framework seamlessly with existing IT infrastructure without sacrificing security requirements (i.e., compliance to the DFARS Clause 252.204-7012). Therefore, all of present invention will be based on plug-ins and add-ons.

Hardware Key Storage:

Hardware key storage is basically a USB dongle. There are standard procedures to convert a USB memory to a USB Dongle. This dongle contain user private key which will be used for secure emailing, and also one of the terms in authentication process, i.e., employees will be asked to enter this USB dongle as a part of authentication process.

Lightweight AI Framework:

As well known in the art, the lightweight AI framework for quick detection and prevention of successful intrusions that typically result from a spear phishing exploits that exposes access privileges held by users to an adversary. Once that happens, the adversary gains access to business process and infrastructure, which are not prevented by access control/encryption.

The present invention, provides a weighted multinomial dynamic trust scoring model that continuously calculates and updates for each node (also user and sub-network in phase 2), a trust score that indicates the security status of the entity at any given time slot. The solution has three main sub-modules (1) evidence collection (2) instantaneous trust scoring (3) decision response and management module.

The evidence collection collects behavioral indicators, quantifies them in a novel manner, and saves it into the Blockchain to prevent tampering from the adversary in a given time window. Then, the instantaneous Trust Scoring Module retrieves node specific evidence, to produce a trust score of the node based on the behavior in a time window; and sends it to the Decision Response and Management Module. The Decision Module takes in the trust score, apart from additional inputs from the blockchain that include historical aggregate trust of the node, risk level of the node (which depends on node sub-network membership, role using it, resources it contains) to decide to take a security response (isolate the node, ask to multifactor reauthenticate, send out a broadcast suspicion notification etc.) The diagram of the present invention is shown in drawings.

Conventionally, machine and deep learning for behavioral anomaly scoring and classification are vulnerable to evasion and training data poisoning attacks and require large training data and resources for parameter optimization, that is not suitable for nodes of businesses. In contrast, symbolic and sub-symbolic AI-based approaches are lightweight scoring models which classify computing entities via a trust score suitable for node users. The working hypothesis in the above methods is that any adversarial behavior will be successfully labeled as negative interactions which contribute nothing to the trust score lowering overall scores. However, it is not a surprise that advanced attackers often bypass access control violations by maliciously gaining access privileges of users (e.g., phishing exploits). Thus, negative interactions may be rarely triggered. From a modelling perspective, Josang's and Dempster Shafer is unable to interpret whether the supposedly high ratio of positive and uncertain interactions are subject to suspicion. Hence, there is a need an advanced sub-symbolic AI method.

To solve the above, the present invention, software starts monitoring when a user runs software, the OS retrieves run-time configuration from the registry database. There are four types of operations: (1) open (2) read (3) write (4) delete. There are four User Roles: (1) Organizer, (2) Moderator, (3) Super User, (4) Normal User. There are three entities include (1) Node ID, sub-network ID, User ID, whose trusts need to be monitored. There are four user resources: (1) File, (2) Systems, (3) Processes, (4) Programs. All activities after monitoring and auditing a report will be transferred to the blockchain.

The present invention enables to label each interaction between a user role and a system entity into three mutually exclusive outcomes: positive, negative and uncertain interactions. The negative interactions are obvious security violations of access control policy that may be bypassed by most smart adversaries. The uncertain category includes interactions outside of expected but not necessarily disallowed (important for false alarm reduction). The positive interactions should not be beyond is suspicion given the spear phishing typically can gain access privileges from user roles.

DLP Platform:

The present invention enables 1) enterprise is the owner of devices, and employees can borrow the devices; 2) DLP manages encryption keys for file sharing. Therefore, each enterprise needs to have a secure node to run its own DLP Platform. Since this platform is extremely cybersecurity-sensitive, the present invention intends to integrate maximum cybersecurity measures for its execution by implementing hardware root of trust (RoT).

As conventionally known the most secure way to run such a platform is hardware security modules (HSMs) which are expensive (cost-inefficient) for SMEs (purely hardware solution). Therefore, modifying and updating them is hard.

The present invention enables a software-assisted HSM (SA-HSM) based on Intel SGX tech (Software Guard eXtension). DLP platform will run on SA-HSM (as shown in FIG. 6). CPUs supporting this tech can be converted to an HSM. Core of the present invention SA-HSM (due to its software platform) compared to pure Hardware HSMs is better as following: low-cost, lightweight, updatable/upgradable/maintainable, will manage encryption keys, device leasing, run on an independent computer, does not require administrative work, therefore a seamless plug-and-play solution.

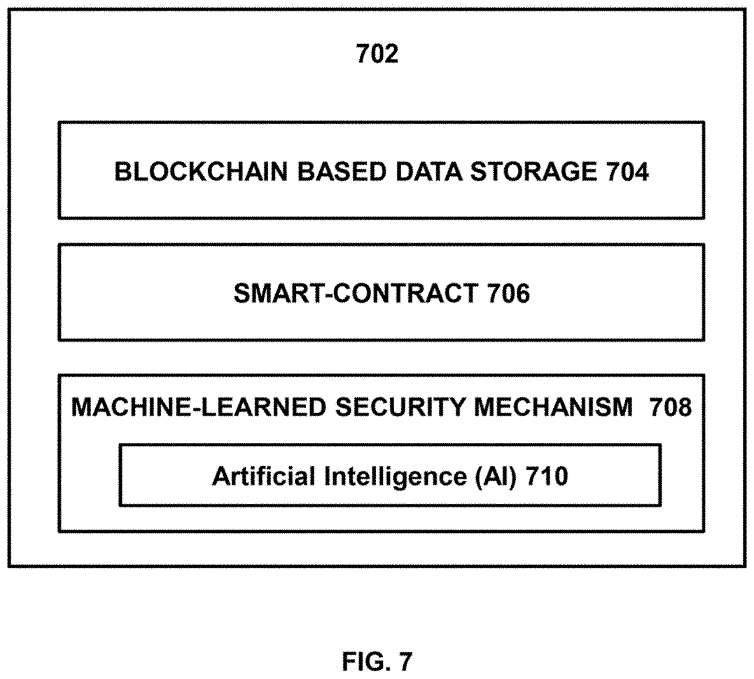

FIG. 7 is a computing device/a plug-and-play device to manage user identities and roles using blockchain and to facilitate secure communication, according to an embodiment of the present invention.

In an embodiment, a computing device 702 to manage user identities and roles using blockchain and to facilitate secure communication is provided.

The computing device includes a blockchain based data storage 704 configured to store one or more transaction records grouped in one or more blocks. A current block of the one or more blocks contains an associated hash along with another hash associated with a former block of the one or more blocks to form a blockchain structure.

The computing device also includes one or more smart-contract 706 associated with the one or more stored transaction records, the one or more smart-contract configured to store information associated with one or more users to enable role-based access control (RBAC) mechanism.

The computing device further includes a machine-learned security mechanism 708 to detect anomaly in behavior of the one or more users based on the stored information or to detect if the computing device is infected, so as to allow secure communication between a user from the one or more users operating the computing device with at least one another user from the computing device or between the computing device and at least one other computing device.

In this embodiment, the computing device further includes a uniquely generated Non-Fungible Token (NFT) indicating authenticity of the computing device.

In this embodiment, when the current block of the one or more blocks is tampered all subsequent blocks after the current block are invalidated.

In this embodiment, the information associated with one or more users is at least selected from an email address, a full name, certificate (i.e., public key), user role, company name, and tenure.

In this embodiment, the computing device is a Universal Serial Bus (USB) dongle.

In this embodiment, the computing device is one of a computer, a laptop, mobile phones, an operation technology (OT), and an Internet of things (IOT) device.

In this embodiment, the machine-learned security mechanism includes an evidence collection mechanism configured to collect behavioral indicators of the one or more users or behavioral indicators of the computing device, quantify them, and store the behavioral indicators into the one or more smart-contract; an instantaneous trust scoring mechanism configured to retrieve the stored information of the one or more users and compare with the collected behavioral indicators of the one or more users or retrieve stored information of the computing device and compare with the collected behavioral indicators of the computing device, to generate a trust score within a pre-defined time; and a decision response and management mechanism configured to trigger at least one action based on the generated trust score and based on historical data associated with the one or more users or historical data associated with the computing device.

In this embodiment, the computing device is configured to perform a two-factor authentication to authenticate the one or more users at least by utilizing a first authentication based on a user name and a password, and a second authentication in the form of authentication tokens to allow the secure communication.

In this embodiment, the machine-learned security mechanism comprises an Artificial Intelligence (AI) 710 that predicts a potential vulnerability before allowing the secure communication and generates one or more recommendations for an administrator, and generates one or more security incident and event management (SIEM) message for security incident reporting purposes based on prediction of the potential vulnerability before allowing the secure communication.

In another embodiment, a plug-and-play device 702 to manage user identities and roles using blockchain and to facilitate secure communication is provided.

The plug-and-play device includes a blockchain based data storage 704 configured to store one or more transaction records grouped in one or more blocks. A current block of the one or more blocks contains an associated hash along with another hash associated with a former block of the one or more blocks to form a blockchain structure.

The plug-and-play device also includes one or more smart-contract 706 associated with the one or more stored transaction records, the one or more smart-contract configured to store information associated with one or more users to enable role-based access control (RBAC) mechanism.

The plug-and-play device further includes a machine-learned security mechanism 708 to detect anomaly in behavior of the one or more users based on the stored information or to detect if a computing device, to which the plug-and-play device is connected to, is infected, so as to allow secure communication between a user from the one or more users operating the computing device with at least one another user from the computing device or between the computing device and at least one other computing device.

In this embodiment, the plug-and-play device further includes a uniquely generated Non-Fungible Token (NFT) indicating authenticity of the computing device.

In this embodiment, when the current block of the one or more blocks is tampered all subsequent blocks after the current block are invalidated.

In this embodiment, the information associated with one or more users is at least selected from an email address, a full name, certificate (i.e., public key), user role, company name, and tenure.

In this embodiment, the plug-and-play device is a Universal Serial Bus (USB) dongle.

In this embodiment, the plug-and-play device is one of a computer, a laptop, mobile phones, an operation technology (OT), and an Internet of things (IOT) device.

In this embodiment, the machine-learned security mechanism includes an evidence collection mechanism configured to collect behavioral indicators of the one or more users or behavioral indicators of the computing device, quantify them, and store the behavioral indicators into the one or more smart-contract; an instantaneous trust scoring mechanism configured to retrieve the stored information of the one or more users and compare with the collected behavioral indicators of the one or more users or retrieve stored information of the computing device and compare with the collected behavioral indicators of the computing device, to generate a trust score within a pre-defined time; and a decision response and management mechanism configured to trigger at least one action based on the generated trust score and based on historical data associated with the one or more users or historical data associated with the computing device.

In this embodiment, the plug-and-play device is configured to perform a two-factor authentication to authenticate the one or more users at least by utilizing a first authentication based on a user name and a password, and a second authentication in the form of authentication tokens to allow the secure communication.

In this embodiment, the machine-learned security mechanism comprises an Artificial Intelligence (AI) 710 that predicts a potential vulnerability before allowing the secure communication and generates one or more recommendations for an administrator, and generates one or more security incident and event management (SIEM) message for security incident reporting purposes based on prediction of the potential vulnerability before allowing the secure communication.

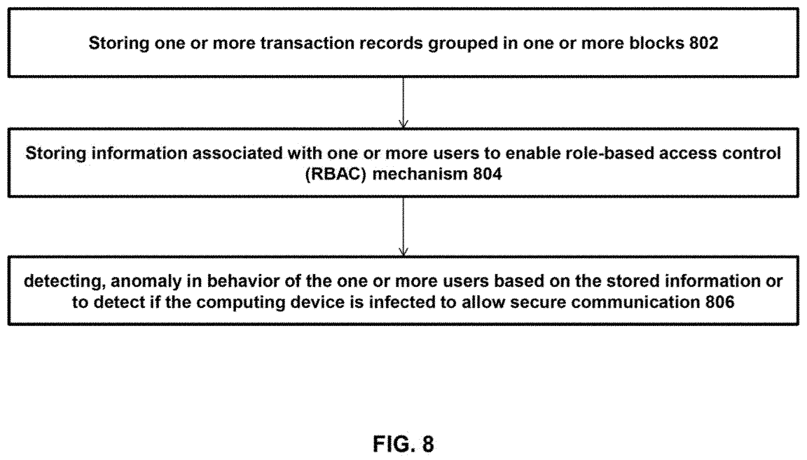

FIG. 8 is a method performed by the computing device/a plug-and-play device as shown in FIG. 7.

In an embodiment, a method to manage user identities and roles using blockchain and to facilitate secure communication is disclosed.

At step 802, a blockchain based data storage stores one or more transaction records grouped in one or more blocks. A current block of the one or more blocks contains an associated hash along with another hash associated with a former block of the one or more blocks to form a blockchain structure

At step 804, one or more smart-contract associated with the one or more stored transaction records stores information associated with one or more users to enable role-based access control (RBAC) mechanism.

At step 806, a machine-learned security mechanism detects anomaly in behavior of the one or more users based on the stored information or to detect if the computing device is infected, so as to allow secure communication between a user from the one or more users operating the computing device with at least one another user from the computing device or between the computing device and at least one other computing device.

In this embodiment, the method further includes the step of invalidating all subsequent blocks after the current block when the current block of the one or more blocks is tampered.

In this embodiment, the method further includes the step of performing a two-factor authentication to authenticate the one or more users at least by utilizing a first authentication based on a user name and a password, and a second authentication in the form of authentication tokens to allow the secure communication.

In this embodiment, the method further includes the step of predicting, by an Artificial Intelligence (AI) of the machine-learned security mechanism, that a potential vulnerability before allowing the secure communication and generating one or more recommendations for an administrator, and generating one or more security incident and event management (SIEM) message for security incident reporting purposes based on prediction of the potential vulnerability before allowing the secure communication.

In this embodiment, the method further includes the step of performing detection of, based on the blockchain, one or more phishing email received at the computing device; or performing secure email communication, based on the blockchain, from the computing device; or performing secure file sharing, based on the blockchain, from the computing device, wherein the secure file sharing is performed based on role-based access control (RBAC) mechanism; or performing secure identity access management, based on the blockchain, in the computing device; or performing secure control access management, based on the blockchain, in the computing device; and secure device management, based on the blockchain, in the computing device.

In this embodiment, the computing device is configured to perform at least one of: detection of, based on the blockchain, one or more phishing email received at the computing device; secure email communication, based on the blockchain, from the computing device; secure file sharing, based on the blockchain, from the computing device, wherein the secure file sharing is performed based on role-based access control (RBAC) mechanism; secure identity access management, based on the blockchain, in the computing device; secure control access management, based on the blockchain, in the computing device; and secure device management, based on the blockchain, in the computing device.

In an example, according to the present invention model, each employee has a dedicated NFT. The NFT is authorized by the company who owns the NFT. The NFT contains the employee information like email, company name, public key (or Certificate), user role (employee, manager, supervisor etc.) and access based on the user role.

When employee A in company X want to send a secure email to the employee B in company Y. it should follow the following process:

Employee A write the email of the recipient (Employee B in company X);

The developed add-on or plugin which is added to the email software client (e.g. Outlook) will search through the blockchain and find the user's NFT and readout the user required information and bring it back to the email software client;

Then the employee A will encrypt the email with employee B public key and sign it with his own private key;

When user B receives the email, the add-on automatically by looking into the email address, look for the sender's NFT in blockchain, and read required information from the corresponded NFT;

If the person had a valid NFT, it will proceed otherwise raise a warning that it might be a phishing email and phishing attack;

The receiver fetches the information (e.g., public key) and verifies the cryptographic signature of the user. If it is valid then it will decrypt the email;

Such an approach is valid for multiple recipient of the email or only one person. This concept can be done in public or private blockchain.

In another example, as described above, each user has a NFL Users can encrypt the file with the provided software. The software provides the possibility to specify with whom this file can be shared. It is also possible to specify with which group of people or with which role this file can be shared (Role based access control). So the procedure of secure file sharing is as follow:

The user specifies the file can be shared with whom or group of people with the same role;

The user by using the provided software encrypts the file and specifies the person or the roles that, who can decrypt the file.

Then the user share the file into the sharing platform (e.g. drop box, share point, google drive etc.);

The key of the secured file will be shared in the blockchain as a small parts or completely to the decentralized leasing platform (DLP) or a server that keep the keys;

Then when the recipient or people with similar or higher roles download the file and want to decrypt it. The software sends a request to the server or DLP to provide them the key to decrypt the file;

DLP or the server verify the request and read out the user NFL. if he/she has access according to his identity or his role, then the key for the file will be shared with the user, Otherwise the user will not receive the key;

When the software receives the key, it will decrypt the file for the recipient.

Although the present invention herein has been described with reference to particular preferred embodiments thereof, it is to be understood that these embodiments are merely illustrative of the principles and applications of the invention. Therefore, modifications may be made to these embodiments and other arrangements may be devised without departing from the spirit and scope of the invention, which is defined by the appended claims.

What is claimed is:

1. A computing device to manage user identities and roles using blockchain and to facilitate secure communication, the computing device comprising:
a blockchain based data storage configured to store one or more transaction records grouped in one or more blocks, wherein a current block of the one or more blocks contains an associated hash along with another hash associated with a former block of the one or more blocks to form a blockchain structure;
one or more smart-contract associated with the one or more stored transaction records, the one or more smart-contract configured to store information associated with one or more users to enable role-based access control (RBAC) mechanism;
a machine-learned security mechanism to detect anomaly in behavior of the one or more users based on the stored information or to detect if the computing device is infected, so as to allow secure communication between a user from the one or more users operating the computing device with at least one another user from the computing device or between the computing device and at least one other computing device.

2. The computing device of claim 1, wherein the computing device further comprising a uniquely generated Non-Fungible Token (NFT) indicating authenticity of the computing device.

3. The computing device of claim 1, wherein when the current block of the one or more blocks is tampered all subsequent blocks after the current block are invalidated.

4. The computing device of claim 1, wherein the information associated with one or more users is at least selected from an email address, a full name, certificate (i.e., public key), user role, company name, and tenure.

5. The computing device of claim 1, wherein the computing device is selected from one of a Universal Serial Bus (USB) dongle, a computer, a laptop, a mobile phone, an operation technology (OT), and an Internet of things (IOT) device.

6. The computing device of claim 1, wherein the computing device is configured to perform at least one of:
detection of, based on the blockchain, one or more phishing email received at the computing device;
secure email communication, based on the blockchain, from the computing device;
secure file sharing, based on the blockchain, from the computing device, wherein the secure file sharing is performed based on role-based access control (RBAC) mechanism;
secure identity access management, based on the blockchain, in the computing device;
secure control access management, based on the blockchain, in the computing device; and
secure device management, based on the blockchain, in the computing device.

7. The computing device of claim 1, wherein the machine-learned security mechanism comprises:
an evidence collection mechanism configured to collect behavioral indicators of the one or more users or behavioral indicators of the computing device, quantify them, and store the behavioral indicators into the one or more smart-contract;
an instantaneous trust scoring mechanism configured to retrieve the stored information of the one or more users and compare with the collected behavioral indicators of the one or more users or retrieve stored information of the computing device and compare with the collected behavioral indicators of the computing device, to generate a trust score within a pre-defined time; and
a decision response and management mechanism configured to trigger at least one action based on the generated trust score and based on historical data associated with the one or more users or historical data associated with the computing device.

8. The computing device of claim 1, wherein the computing device is configured to perform a two-factor authentication to authenticate the one or more users at least by utilizing a first authentication based on a user name and a password, and a second authentication in the form of authentication tokens to allow the secure communication.

9. The computing device of claim 1, wherein the machine-learned security mechanism comprises an Artificial Intelligence (AI) that predicts a potential vulnerability before allowing the secure communication and generates one or more recommendations for an administrator, and generates one or more security incident and event management (SIEM) message for security incident reporting purposes based on prediction of the potential vulnerability before allowing the secure communication.

10. A plug-and-play device to manage user identities and roles using blockchain and to facilitate secure communication, the plug-and-play device comprising:
a blockchain based data storage configured to store one or more transaction records grouped in one or more blocks, wherein a current block of the one or more blocks contains an associated hash along with another hash associated with a former block of the one or more blocks to form a blockchain structure;
one or more smart-contract associated with the one or more stored transaction records, the one or more smart-contract configured to store information associated with one or more users to enable role-based access control (RBAC) mechanism;
a machine-learned security mechanism to detect anomaly in behavior of the one or more users based on the stored information or to detect if a computing device, to which the plug-and-play device is connected to, is infected, so as to allow secure communication between a user from the one or more users operating the computing device with at least one another user from the computing device or between the computing device and at least one other computing device.

11. The plug-and-play device of claim 10, wherein the plug-and-play device further comprising a uniquely generated Non-Fungible Token (NFT) indicating authenticity of the plug-and-play device.

12. The plug-and-play device of claim 10, wherein when the current block of the one or more blocks is tampered all subsequent blocks after the current block are invalidated.

13. The plug-and-play device of claim 10, wherein the information associated with one or more users is at least selected from an email address, a full name, certificate (i.e., public key), user role, company name, and tenure.

14. The plug-and-play device of claim 10, wherein the plug-and-play device is configured to perform at least one of:
detection of, based on the blockchain, one or more phishing email received at the computing device;
secure emailing, based on the blockchain, from the computing device;
secure file sharing, based on the blockchain, from the computing device, wherein the secure file sharing is performed based on role-based access control (RBAC) mechanism;
secure identity access management, based on the blockchain, in the computing device;
secure control access management, based on the blockchain, in the computing device; and secure device management, based on the blockchain, in the computing device.

15. The plug-and-play device of claim 10, wherein the machine-learned security mechanism comprises:
an evidence collection mechanism configured to collect behavioral indicators of the one or more users or behavioral indicators of the computing device, quantify them, and store the behavioral indicators into the one or more smart-contract;
an instantaneous trust scoring mechanism configured to retrieve the stored information of the one or more users and compare with the collected behavioral indicators of the one or more users or retrieve stored information of the computing device and compare with the collected behavioral indicators of the computing device, to generate a trust score within a pre-defined time; and
a decision response and management mechanism configured to trigger at least one action based on the generated trust score and based on historical data associated with the one or more users or historical data associated with the computing device.

16. The plug-and-play device of claim 10, wherein the plug-and-play device is configured to perform a two-factor authentication to authenticate the one or more users at least by utilizing a first authentication based on a user name and a password, and a second authentication in the form of authentication tokens to allow the secure communication.

17. The plug-and-play device of claim 7, wherein the machine-learned security mechanism comprises an Artificial Intelligence (AI) that predicts a potential vulnerability before allowing the secure communication and generates one or more recommendations for an administrator, and generates one or more security incident and event management (SIEM) message for security incident reporting purposes based on prediction of the potential vulnerability before allowing the secure communication.

18. A method to manage user identities and roles using blockchain and to facilitate secure communication, the method comprising:
storing, in a blockchain based data storage, one or more transaction records grouped in one or more blocks, wherein a current block of the one or more blocks contains an associated hash along with another hash associated with a former block of the one or more blocks to form a blockchain structure;
storing, in one or more smart-contract associated with the one or more stored transaction records, information associated with one or more users to enable role-based access control (RBAC) mechanism;
detecting, by a machine-learned security mechanism, anomaly in behavior of the one or more users based on the stored information or to detect if the computing device is infected, so as to allow secure communication between a user from the one or more users operating the computing device with at least one another user from the computing device or between the computing device and at least one other computing device.

19. The method of claim 18, further comprising: invalidating all subsequent blocks after the current block when the current block of the one or more blocks is tampered.

20. The method of claim 18, further comprising:
performing a two-factor authentication to authenticate the one or more users at least by utilizing a first authentication based on a user name and a password, and a second authentication in the form of authentication tokens to allow the secure communication; or
predicting, by an Artificial Intelligence (AI) of the machine-learned security mechanism, that a potential vulnerability before allowing the secure communication and generating one or more recommendations for an administrator, and generating one or more security incident and event management (SIEM) message for security incident reporting purposes based on prediction of the potential vulnerability before allowing the secure communication.
